(19) United States
(12) Patent Application Publication
(10) Pub. No.: US 2023/0173584 A1
(43) Pub. Date: Jun. 8, 2023

(54) MODULAR TRAY FOR THE POWDER BED ADDITIVE MANUFACTURING OF A PART WITH AN AXIS OF REVOLUTION

(71) Applicants: SAFRAN HELICOPTER ENGINES, Bordes (FR); SAFRAN TRANSMISSION SYSTEMS, Colombes (FR)

(72) Inventors: Arnaud Georges NIFENECKER, Moissy-Cramayel (FR); Jérémi Christophe Benjamin ADOR, Moissy-Cramayel (FR); Frédéric AYCAGUER, Moissy-Cramayel (FR); Frédéric Jacques DUFAU, Moissy-Cramayel (FR); Gilles Gaston Jacques GOUIN, Moissy-Cramayel (FR); Jean-Pierre WILMES, Izernore (FR); Werner ARGUEL, Izernore (FR)

(73) Assignees: SAFRAN HELICOPTER ENGINES, Bordes (FR); SAFRAN TRANSMISSION SYSTEMS, Colombes (FR)

(21) Appl. No.: 17/995,465

(22) PCT Filed: Mar. 31, 2021
(86) PCT No.: PCT/FR2021/050566

§ 371 Date: Oct. 4, 2022

(30) Foreign Application Priority Data
Apr. 6, 2020 (FR) 2003422

(51) Int. Cl. B22F 12/37; B22F 10/28; B22F 10/66; B22F 12/82; B22F 10/64; B33Y 30/00; B33Y 40/20; B33Y 10/00; B22F 10/47; B29C 64/245; B29C 64/153; B29C 64/30

(52) U.S. Cl. CPC B22F 12/37; B22F 10/28; B22F 10/66; B22F 12/82; B22F 10/64; B33Y 30/00; B33Y 40/20; B33Y 10/00; B22F 10/47; B29C 64/245; B29C 64/153; B29C 64/30; B22F 2998/10

(57) ABSTRACT

A modular tray, for the additive manufacturing of a part with an axis of revolution on a powder bed, includes: a shaft-mounted circular module including a shaft provided with a circular tray at one of the ends thereof, the shaft and the circular tray being concentric; and a main support module including, in one face, a cavity configured for receiving the shaft-mounted circular module, the shaft being completely inserted in the cavity. The assembly of the shaft-mounted circular module and of the main support module define a planar top surface that is at least partly formed by the circular tray of the shaft-mounted circular module.

### TECHNICAL FIELD

The present invention relates to the field of the additive manufacturing, on a powder bed, of a part with an axis of revolution, and more particularly a tray used for implementing this manufacturing technique, also referred to as 3D manufacture.

### PRIOR ART

The manufacturing of a part of revolution by additive manufacturing on a powder bed requires firstly the use of support elements and secondly the separation of the blank from the tray on which it was manufactured, this separation being implemented by saw cutting, electroerosion (or electrical discharge machining, EDM), etc. The powder used may be metallic, ceramic or polymer (for example PEEK). In the context of the present application, the term “metallic” includes pure metals and alloys.

These support elements are created, like the part, by localised melting or localised sintering (by means of a laser beam or a beam of electrons) of the powder during the formation of the part. They make it possible to support portions of the part requiring support and/or to connect the portions of the part together. These support elements are intended to be destroyed after the blank is formed.

Some geometries of parts require a very large quantity of support elements. This is the case for example with parts having stages with different diameters, for example an outer ring positioned halfway up the hub, in the case of a sprocket.

By way of example, FIG. 1 illustrates the support elements necessary for manufacturing a sprocket in additive manufacturing on a steel powder bed on a conventional tray 6. For reasons of simplification, only one half of the image has been shown, the other half being symmetrical with respect to the symmetry plane illustrated by the broken line A, which also represents the axis of revolution 1 of the part to be produced. The sprocket includes in particular, on either side of an outer ring 5 (which includes the rim and the teeth of the sprocket), a main hub 26 on one side, and on the other an inner hub 2 and an outer hub 3; it also includes a web 4. In a gear, for example a sprocket, the web is the part connecting the rim, on which the teeth are located, to the hub.

The sprocket is manufactured on an additive manufacturing tray 6 (generally square or rectangular in form) and the manufacture thereof requires the use of a support element 7 for supporting the web 4 and the outer ring 5 (the support element 7 including holes 8 facilitating the removal of powder from the part), of a support element 9 for supporting the outer hub 3, and of a support element 10 that itself will support the support element 7.

Thus the quantity of support elements necessary for manufacturing a part with an axis of revolution may be significant, which significantly impacts on the quantity of powder used and the time for lasering the part.

Furthermore, separating the part from the tray (conventionally square or rectangular in form) on which it was formed requires a dedicated operation using a saw, an electroerosion machine or other.

The blank must then undergo machining in order to remove the support elements from it.

### DISCLOSURE OF THE INVENTION

The objective sought for the invention is the optimisation of implementation in terms of duration (melting/sintering and machining) of parts with an axis of revolution by additive manufacturing on a powder bed (in particular by SLM (selective laser melting), by EBM (electron beam melting) and by SLS (selective laser sintering)), in particular for producing sprockets, in particular for producing parts with stages with increasing diameters of great amplitude, such as sprockets with webs halfway up the hub.

The aim of the invention is in particular to provide a simple and effective solution to the problems raised above.

For this purpose, the invention proposes a modular tray for the additive manufacturing of a part with an axis of revolution on a powder bed, characterised in that it comprises:

a shaft-mounted circular module comprising a shaft provided with a circular tray at one of the ends thereof, the shaft and the circular tray being concentric; and

a main support module including, in one face, a cavity configured for receiving the shaft-mounted circular module, the shaft being completely inserted in the cavity;

the assembly of the shaft-mounted circular module and of the main support module defining a planar top surface that is at least partly formed by the circular tray of the shaft-mounted circular module.

The main support module may for example be a tray. It may be square, rectangular or circular.

According to a variant of the invention, the modular tray furthermore comprises an annular module and the main support module furthermore includes an annular cavity configured for receiving the annular module. According to this variant, the annular cavity and the cavity of the shaft-mounted circular module are concentric. Furthermore, the annular module, once assembled with the shaft-mounted circular module and with the main support module, forms a portion of the planar top surface of the assembly.

According to a variant of the invention, the shaft-mounted circular module and the optional annular module are machined, preferably by turning.

Advantageously, the shaft of the shaft-mounted circular module is a preform of one end of the part to be manufactured.

The invention also proposes a method for manufacturing a part with an axis of revolution, comprising:

the production, by localised melting or localised sintering of a powder on a modular tray as described above, of a blank with an axis of revolution and of at least one element supporting this blank, the melted or sintered powder and the modular tray being in contact solely:

on the circular tray of the shaft-mounted circular module, thus forming a portion of the part and an optional element supporting the part; and

optionally on the annular module, thus forming an optional other element supporting the part;

the axis of revolution of the blank being coaxial with the axis of the shaft of the shaft-mounted circular module;

the removal, from the main support module, of the assembly formed by the blank, the shaft-mounted circular module and the optional annular module;

the removal of powder from this assembly;

the placing of the assembly on a device lathe for machining by turning;

the machining by turning of a first portion (B) of the blank;

if the assembly includes an annular module, the separation of the blank from said annular module by cutting by turning, the cutting being implemented on the support element connecting the blank to the annular module along a cutting plane (C) perpendicular to the axis of revolution of the blank;

the machining by turning of a second portion (D) of the blank, by means of which:

the optional support element remaining at the end of the separation step is completely eliminated;

the optional support element connecting the blank to the shaft-mounted circular module is completely eliminated; and

the shaft-mounted circular module is partially eliminated, the non-eliminated portion of said shaft-mounted circular module being integrated in the blank;

the steps of machining by turning (B) (D) and the optional step of separation by turning being implemented by rotating the blank about the axis of the shaft of the shaft-mounted circular module;

by means of which the part with an axis of revolution is obtained.

According to one embodiment, the shaft of the shaft-mounted circular module is pre-machined so as to form a preform of one end of the part to be produced.

Preferably, the shaft-mounted circular module is produced from the same material as that of the part to be produced.

According to a variant of the invention, the method furthermore comprises at least one step of hardening heat treatment of the part, this step being implemented between the steps of removing powder from the assembly and of placing this assembly on a device lathe for machining by turning, and/or after the step of machining by turning of the second portion of the blank.

The solution proposed in accordance with the invention has many advantages.

According to the invention, the melting or sintering of the part and of the support elements on the modular tray takes place solely on removable modules that can be removed from the main support module; the melting or sintering of the powder therefore takes place on the shaft-mounted circular module and on the optional annular module, but not on the main support module. As these removable modules are coaxial, it is possible to proceed with the machining of the part and with the removal of the support elements by positioning the assembly formed by the part and this or these removable modules on a lathe. Thus the blank obtained at the end of the additive manufacturing (SLM, EBM, etc.) can be directly machined, by being placed on a lathe, without first of all requiring a step for disconnecting the blank from the additive manufacturing tray. In this way an operation is saved on during which the blank might be exposed to corrosion problems.

Moreover, since the shaft of the shaft-mounted circular module may be a preform of one end of the part to be manufactured and since this shaft may be pre-machined, the method according to the invention makes it possible to greatly limit the quantity of support elements necessary during the manufacturing of the part, which ultimately limits the time taken for lasering and machining the part, and also limits the quantity of powder used. Here lasering is spoken of, but naturally it is also possible to use a beam of electrons in place of a laser beam.

### BRIEF DESCRIPTION OF THE DRAWINGS

The invention will be best understood and other details, features and advantages of the invention will emerge from the reading of the description made by way of non-limitative example with reference to the accompanying drawings, which illustrate:

FIG. 1 (already detailed above), a schematic view in cross section of a blank with an axis of revolution and of its support elements obtained by additive manufacturing on a powder bed on a tray of the prior art;

FIG. 2a, a schematic view in 3 dimensions showing the rear face of the assembly formed by the blank and by its support elements as illustrated in FIG. 1, once detached from the conventional tray;

FIG. 2b, a schematic view in 3 dimensions showing the front face of this assembly;

FIG. 3, an exploded schematic view of the modules of the modular tray according to a variant of the invention;

FIG. 4, a schematic view in cross section of the modular tray illustrated in FIG. 3;

FIG. 5, an exploded schematic view of the modules of the modular tray according to another variant of the invention;

FIG. 6, a schematic view in cross section of the modular tray illustrated in FIG. 5;

FIG. 7a, an explanatory diagram of a step of the manufacturing method according to a first embodiment of the invention using the modular tray of FIG. 6;

FIG. 7b, an explanatory diagram of a step of the manufacturing method according to a first embodiment of the invention using the modular tray of FIG. 6;

FIG. 7c, an explanatory diagram of a step of the manufacturing method according to a first embodiment of the invention using the modular tray of FIG. 6;

FIG. 7d, an explanatory diagram of a step of the manufacturing method according to a first embodiment of the invention using the modular tray of FIG. 6;

FIG. 7e, an explanatory diagram of a step of the manufacturing method according to a first embodiment of the invention using the modular tray of FIG. 6;

FIG. 7f, an explanatory diagram of a step of the manufacturing method according to a first embodiment of the invention using the modular tray of FIG. 6;

FIG. 7g, an explanatory diagram of a step of the manufacturing method according to a first embodiment of the invention using the modular tray of FIG. 6;

FIG. 8, a schematic view in cross section of a blank with an axis of revolution and of its support elements obtained by additive manufacturing on a powder bed on the modular tray of FIG. 5 (the main support module already having been removed);

FIG. 9, a schematic view in cross section of a blank with an axis of revolution and of its support elements obtained by additive manufacturing on a powder bed on the modular tray of FIG. 3.

### DETAILED DESCRIPTION OF EMBODIMENTS

According to the invention, the additive manufacturing tray is formed from one or more removable modules, placed in cavities in a face of a main support module so as to define a planar surface on which the powder bed will be able to be spread; the powder will be melted or sintered only on these removable modules so that once the part has been formed, the assembly formed by the part and the removable modules will be able to be mounted—after removal of powder—on a lathe and thus insert the operation of separating the part and removable modules from the tray among the operations of turning the blank and finishing the part.

As illustrated in FIG. 3, the modular tray 12 includes at least a shaft-mounted circular module 13 and a main support module 16, having a cavity 17 in its top face to house therein the shaft-mounted circular module 13.

As illustrated in FIG. 4, which shows a view in cross section of the assembly of the main support tray 16 and of the shaft-mounted circular module 13, the shaft-mounted circular module 13 is a single-piece assembly including a shaft 14 provided at one of the ends thereof with a circular tray 15.

Preferably, the shaft is pre-machined so as to be a preform of one end of the part to be produced. In a first example illustrated in FIG. 4, the shaft is a preform of the main hub 26 of the part. In another example illustrated in FIG. 6, the shaft is a preform of the inner hub 2 and of the outer hub 3 of the part.

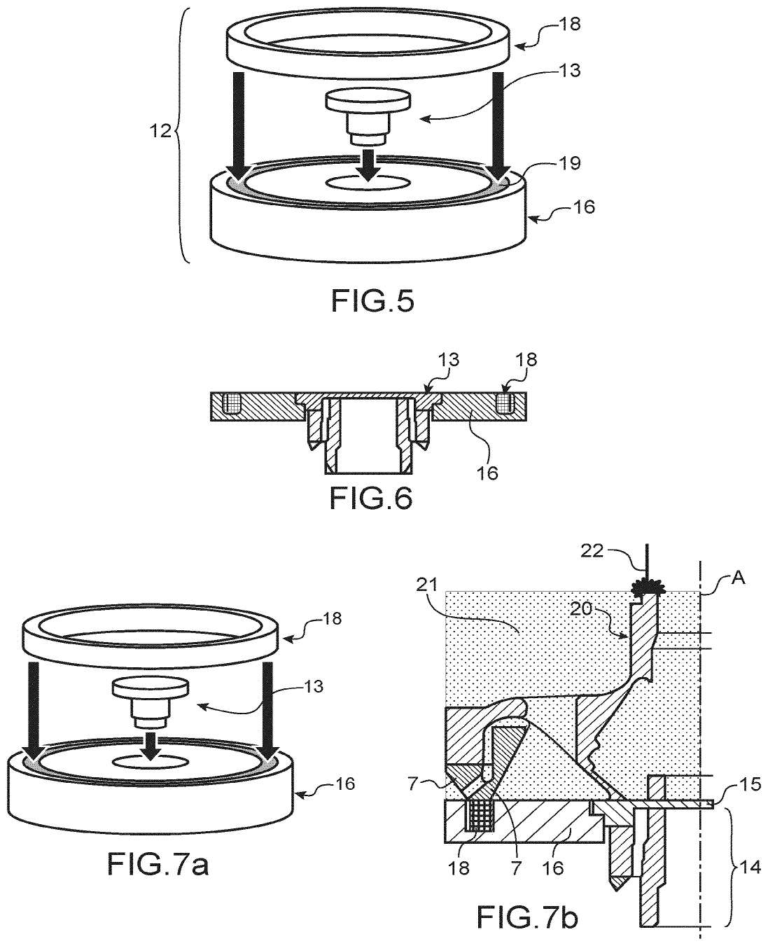

The modular tray 12 may also include an annular module 18, intended to come to be housed in an annular cavity 19 (annular groove) present in the top face of the main support module 16 (FIGS. 5 and 6).

In FIGS. 3 and 5, the main support module is circular, but it could also have another form, for example square or rectangular.

We shall now describe the manufacture of a part with an axis of revolution according to a first embodiment of the method according to the invention using the modular tray as illustrated in FIG. 6.

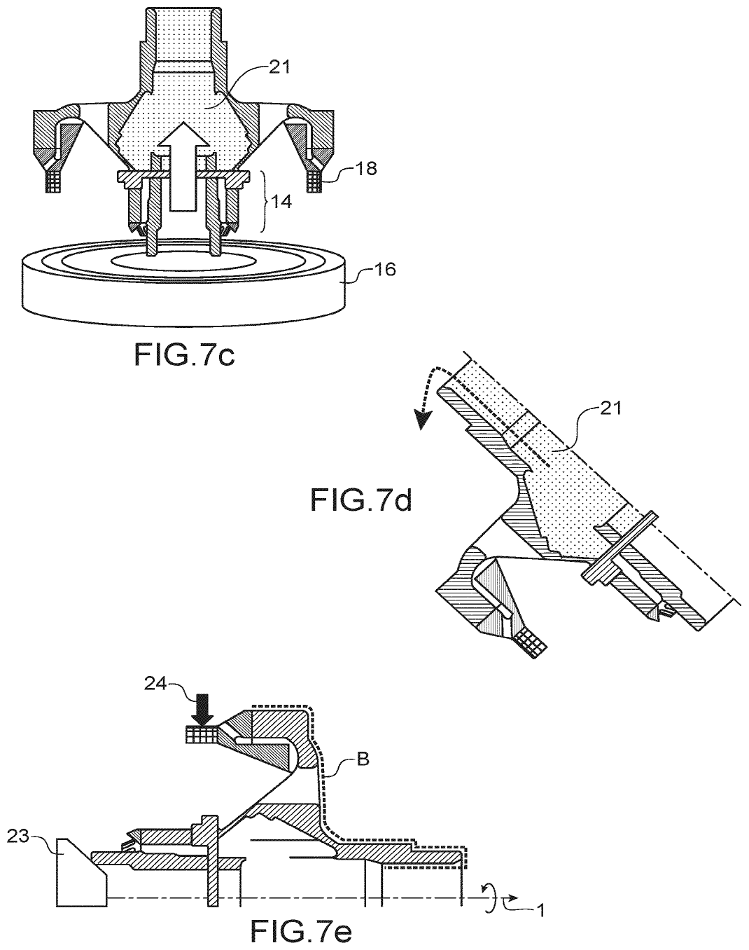

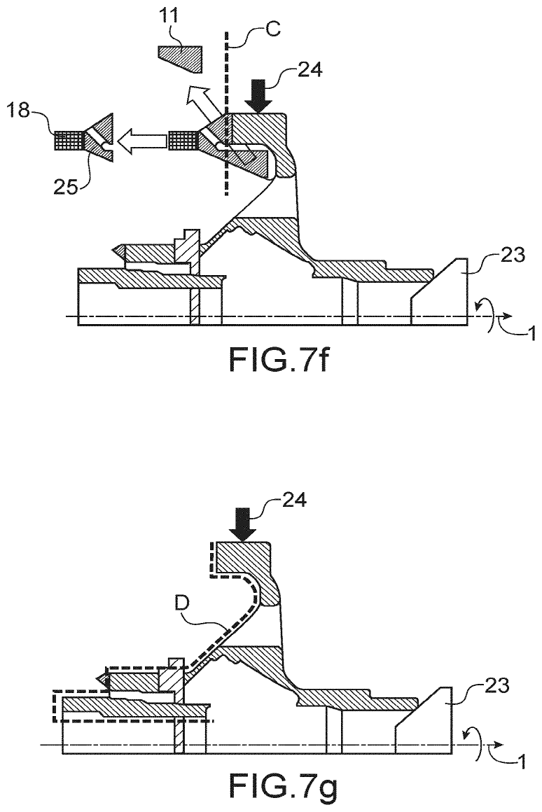

The shaft-mounted circular module 13 and the annular module 18 are placed in their respective cavities 17 and 19 of the main support module 16 (FIG. 7a).

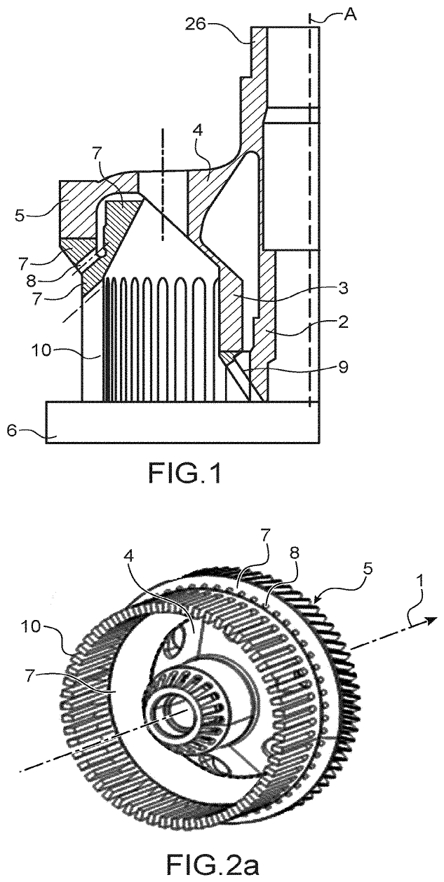

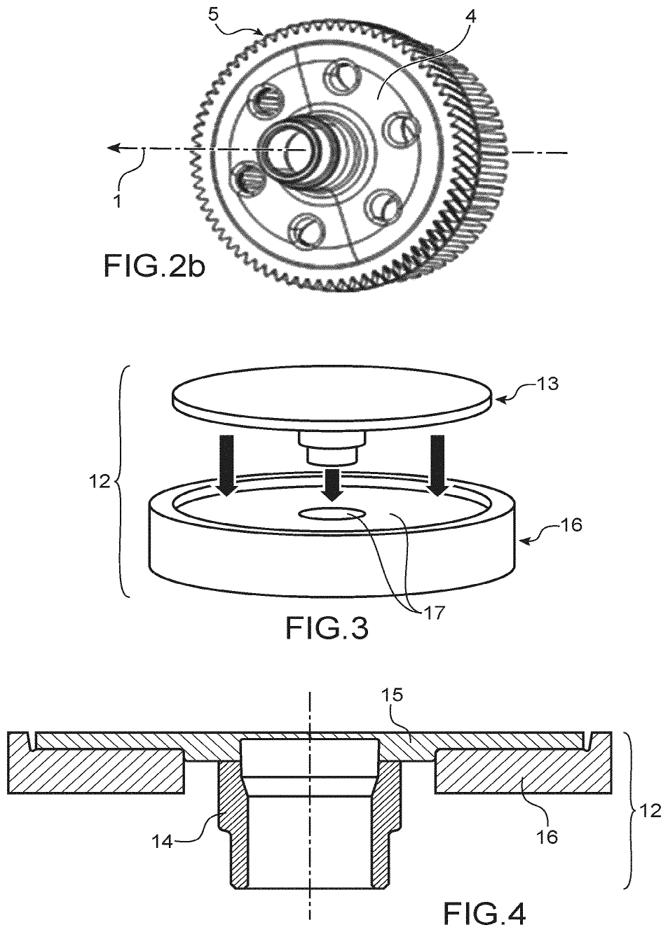

The manufacture of the blank 20 by selective melting or selective sintering of a powder is next proceeded with (FIG. 7b). The powder used may be metallic, ceramic or polymer. The blank 20 is produced layer by layer by a conventional additive manufacturing method. As in FIG. 1 and for reasons of simplification, only a half of the image has been shown, the other half being symmetrical with respect to the symmetry plane illustrated by the broken line A, which also shows the axis of revolution 1 of the part to be produced.

In the step of producing the blank 20 and the support element 7 on the modular tray 12, the part and the support element are for example constructed layer by layer by selective melting or selective sintering of the powder 21 by means of a laser beam 22, the powder 21 having a mean granulometry of between 10 and 50 μm, or by means of a beam 22 of electrons, the powder 21 having a mean granulometry of between 50 and 100 μm.

In this example embodiment (FIG. 7b), the melted or sintered powder on the circular tray 15 of the shaft-mounted circular module 13 forms a portion of the part, whereas the melted or sintered powder on the annular module 18 forms first the support element 7 and then a portion of the part.

Once the part is finished, it is removed from the main support module 16, the part being integral with the shaft-mounted circular module 13 and the annular module 18 (hereinafter referred to as removable modules) (FIG. 7c).

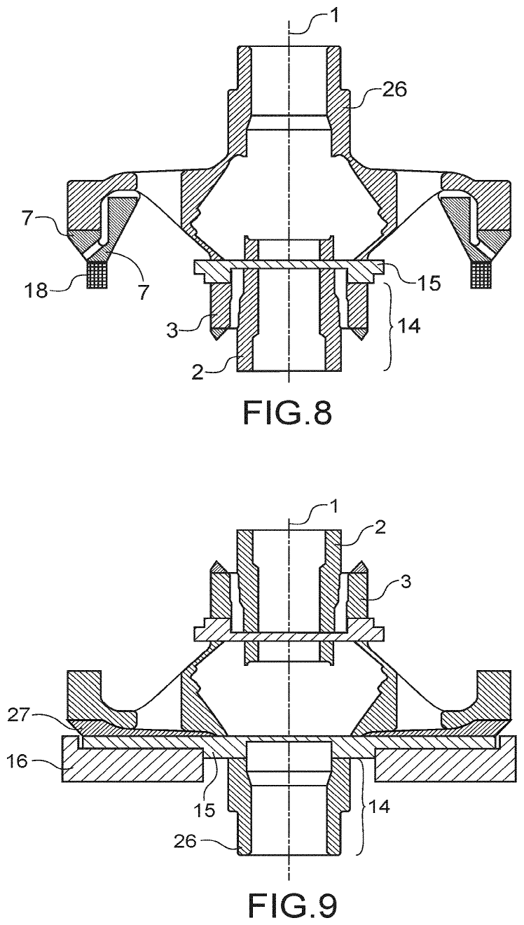

Then the part has the powder removed from it (FIG. 7d). The powder removal may be done by suction, blowing, vibration or by turning over the blank so that the powder escapes by gravity. At the end of the powder removal the assembly as illustrated in FIG. 8 is obtained.

Then the assembly formed by the blank and the removable modules is installed on a lathe and the turning of a first portion of the part (here referred to as the front face of the part) is proceeded with (FIG. 7e). The turning is done by rotation about the axis of the shaft 14 of the shaft-mounted circular module (which corresponds to the axis of revolution 1 of the part). The supports of the part/removal modules assembly on the lathe are represented by the member 23 and the member shown by the arrow 24 (for example a clamping chuck). The machining of the front face is symbolised by the broken line B.

The blank is next separated from the annular module 18 by cutting along a cutting plane C perpendicular to the axis of revolution of the part (which is also the axis of rotation of the lathe and the axis of the shaft 14) at the support element 7 (FIG. 7f). The turning can for example be implemented by means of a grooved tool. Among the detached elements, there are thus firstly an element 11 that is a portion of the support element 7, and secondly an element 25 that is formed by the other portion of the support element 7 and of the annular module 18.

It should be noted that it is possible to implement one or more heat treatments of the part during manufacture thereof. For example, once the powder removal has been implemented (FIG. 7d), it is possible to subject the blank to a stress-release heat treatment before proceeding with the step 7e, for example by heating the part to a temperature below the sintering temperature of the powder, for a given period. Following the step 7g, it is possible to subject the part to a hardening heat treatment.

These same steps of the method according to the invention can also be implemented according to a second embodiment by using the modular tray as illustrated in FIGS. 3 and 4 for obtaining the part as illustrated in FIG. 9.

Whereas in a first embodiment (FIG. 8) the powder was melted or sintered both on the shaft-mounted circular module 13 and on the annular module 18, in this second embodiment the powder will be melted or sintered solely on the shaft-mounted circular module 13 to form both a portion of the part, and the support element 27 of the web. Thus, at the end of the powder removal step, the assembly illustrated in FIG. 9 is obtained in place of the assembly illustrated in FIG. 8. The machining will make it possible to remove the support element 27 and to rework all the precise dimensions of the part.

We have compared the mass of powder lasered, as well as the lasering time necessary for producing the same part with an axis of revolution manufactured by the conventional technique requiring all the support elements described in FIG. 1 (part serving as a reference), by the first embodiment according to the invention (obtaining the blank illustrated in FIG. 8) and by the second embodiment according to the invention (obtaining the blank illustrated in FIG. 9). The results are presented in the following table.

TABLE
comparison between the conventional technique and two
embodiments according to the invention.

| Technique used | Mass lasered (kg) | Lasering time (h) |
|---|---|---|
| Conventional | 6.115 | 112 |
| Embodiment 1 | 4.496 | 82 |
| Embodiment 2 | 3.821 | 70 |

To manufacture the part by additive manufacturing on a powder bed using a conventional tray, there will be a need for three types of support element (namely the support element 7 for supporting the web 4 and for supporting the outer ring 5, the support element 9 for supporting the outer hub 3 and the support element 10 for supporting the support element 7).

By using the modular tray (FIGS. 5 and 6) according to the first embodiment (illustrated in FIG. 8), there is now a need only for two types of support element, the support element 9 and the support element 10 being omitted.

By using the modular tray (FIGS. 3 and 4) according to the second embodiment (illustrated in FIG. 9), there is now a need only for one hybrid support element 27, which supports both the web and the outer ring, but over a much smaller height than in the first embodiment.

Thus it is found that embodiment 1 affords a saving of 27% on the lasered mass and on the lasering time compared with the conventional technique; as for embodiment 2, this affords a saving of 38% on the lasered mass and on the lasering time.

1-8. (canceled)

9. A modular tray for an additive manufacturing of a part with an axis of revolution on a powder bed, the modular tray comprising:
a shaft-mounted circular module comprising a shaft provided with two ends and with a circular tray at one of the two ends, the shaft and the circular tray being concentric; and
a main support module including, in one face, a cavity configured for receiving the shaft-mounted circular module, the shaft being completely inserted in the cavity,
wherein an assembly of the shaft-mounted circular module and of the main support module defines a planar top surface that is at least partly formed by the circular tray of the shaft-mounted circular module, and
wherein the shaft of the shaft-mounted circular module is a preform of one end of the part to be manufactured.

10. The modular tray according to claim 9, further comprising an annular module,
wherein the main support module further includes an annular cavity configured for receiving the annular module, the annular cavity and the cavity of the shaft-mounted circular module being concentric, and the annular module, once assembled with the shaft-mounted circular module and with the main support module, forming a portion of the planar top surface of the assembly.

11. The modular tray according to claim 9, wherein the shaft-mounted circular module is machined by turning.

12. A method for manufacturing a part with an axis of revolution, comprising:
producing, by localized melting or localized sintering of a powder on a modular tray according to claim 1, a blank with an axis of revolution and at least one element supporting the blank, the melted or sintered powder and the modular tray being in contact solely:
on the circular tray of the shaft-mounted circular module, thus forming a portion of the part and an optional element supporting the part; and
optionally on the annular module, thus forming an optional other element supporting the part;
the axis of revolution of the blank being coaxial with the axis of the shaft of the shaft-mounted circular module;
removing, from the main support module, an assembly formed by the blank, the shaft-mounted circular module and the optional annular module;
removing of powder from the assembly;
placing the assembly on a device lathe for machining by turning;
machining by turning of a first portion of the blank;
if the assembly includes an annular module, separating of the blank from said annular module by cutting by turning, the cutting being implemented on the support element connecting the blank to the annular module along a cutting plane perpendicular to the axis of revolution of the blank;
machining by turning of a second portion of the blank, by which:
the optional support element remaining at the end of the separation step is completely eliminated;
the optional support element connecting the blank to the shaft-mounted circular module is completely eliminated; and
the shaft-mounted circular module is partially eliminated, the non-eliminated portion of said shaft-mounted circular module being integrated in the blank;
the steps of machining by turning and the optional step of separating by turning being implemented by rotating the blank about the axis of the shaft of the shaft-mounted circular module;
by which the part with an axis of revolution is obtained.

13. The manufacturing method according to claim 12, wherein the shaft of the shaft-mounted circular module is pre-machined so as to form a preform of one end of the part to be produced.

14. The manufacturing method according to claim 12, wherein the shaft-mounted circular module is produced from the same material as that of the part to be produced.

15. The manufacturing method according to claim 12, further comprising at least one step of hardening heat treatment of the part, the step being implemented between the steps of removing powder from the assembly and of placing the assembly on a device lathe for machining by turning, and/or after the step of machining by turning of the second portion of the blank.
